(19) United States
(12) Patent Application Publication
(10) Pub. No.: US 2008/0246258 A1
(43) Pub. Date: Oct. 9, 2008

(54) Non-circular burst disk geometry for improved material utilization

(75) Inventors: Bradley W. Smith, Plain City, UT (US); Kenneth Clark, Mountain Green, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/784,557

(22) Filed: Apr. 6, 2007

(51) Int. Cl. B60R 21/26

(52) U.S. Cl. 280/736; 29/557

(57) ABSTRACT

A burst disk for use in an inflator having an orifice. The burst disk includes a surface that may be disposed adjacent to the orifice. This surface includes a first side, a second side, and a non-circular perimeter, wherein at least one diagonal across the first side is greater than or equal to the diameter of the orifice. The burst disk may be generally square or rectangular in shape. By forming the burst disk in this manner, a lesser amount of raw material is needed to make the burst disk. Also, a lesser amount of material is wasted during the manufacturing process.

### BACKGROUND OF THE INVENTION

Airbag systems are known and used in motor vehicles. These airbag systems have greatly increased the safety of motor vehicles and are designed to inflate and position an airbag in front of a vehicle occupant during a crash. A variety of different types of airbags are known including driver's airbags, passenger airbags, side curtain airbags, etc. In the event of an accident or crash, the inflated airbag prevents the occupant from impacting the hard surfaces of the vehicle interior, and thus significantly reduces the likelihood that the occupant will be injured in the crash.

Airbag systems will generally include an airbag inflator (which is sometimes called an “inflator”). The inflator is designed to produce and/or channel a large quantity of inflation gas into the airbag in the event of an accident or crash. This influx of gas into the airbag inflates and deploys the airbag into the vehicle interior.

Many airbag inflators include a chamber that houses a quantity of stored gas. This chamber is sealed with a burst disk that prevents the gas from exiting the chamber prior to deployment. During deployment, this burst disk is ruptured, broken, or otherwise failed. Once this failure of the burst disk occurs, the burst disk is not longer capable of containing the gas within the chamber. Rather, the gas flows out of the chamber and is then channeled into the airbag.

In general, conventional burst disks are round and are made larger than the diameter of the chamber orifice. The purpose of using this larger burst disk is to ensure that the burst disk completely covers and seals the chamber orifice and to provide a region to weld the burst disk outside the chamber orifice as well as a region to hold the disk in place during welding. However, making the burst disk significantly larger than the orifice is wasteful and increases manufacturing costs. Accordingly, it would be an improvement to find a new design for a burst disk that is not required to be significantly greater in size than the size of the orifice. It would also be an improvement to design a new type of burst disk wherein the amount of material wasted during the manufacturing process is reduced. Such a new design for a burst disk is disclosed herein.

### BRIEF SUMMARY OF THE INVENTION

A burst disk is disclosed. The burst disk is designed for use in an inflator having an orifice. More specifically, the burst disk is designed to be positioned adjacent the inflator's orifice. The surface may also comprise a first side, a second side, and a non-circular perimeter. At least one diagonal across the first side is greater than or equal to the diameter of the orifice. In those embodiments in which the inflator includes a well, at least one diagonal of the disk may be equal to or only slightly smaller than the diameter of the inflator well. The present embodiments may also be used with inflators that do not include a well. In some embodiments, the burst disk is generally square or rectangular in shape. As such, the non-circular perimeter may comprise a plurality of first edges, wherein the first edges are parallel. In further embodiments, the non-circular perimeter comprises a plurality of second edges, wherein the second edges are parallel. In yet additional embodiments, the non-circular perimeter comprises a plurality of first arcs. The first arcs may share a common diameter. A plurality of second arcs that share a common diameter may also be used as part of the non-circular perimeter. In some embodiments, the inflator may have a circular well and the first and second arcs correspond to the circular arc of the well. In yet further embodiments, the burst disk is welded to a welding area positioned proximate the orifice. In some embodiments, the burst disk will have the shape of regular or irregular polygon. Further embodiments may be designed in which one or more of the corners may be rounded off. In other embodiments, the burst disk is positioned such that the orifice is inscribed within the burst disk. Other embodiments are designed in which a circular weld positioned exterior of the orifice is added, wherein the diameter of the circular weld is greater than the diameter of the orifice. Additional embodiments are designed in which the distance between the circular weld and the orifice is selected such that the weld is not compromised during deployment. The weld may also be separated from the edge of the burst disk by a distance sufficient to ensure that the edge is not melted during the welding process. Further embodiments are designed in which the burst disk lacks four exterior curved sectors that are present in circular burst disks.

The present embodiments also relate to a method for reducing waste while producing one or more non-circular burst disks. These burst disks are designed for use with the inflators having an orifice. In some embodiments, the method comprises the step of obtaining a strip of material having two longitudinal sides. The method also includes the step of identifying where the strip can be cut to form at least one burst disk, wherein the burst disk comprises a surface for disposition next to the orifice, the surface comprising a first side, a second side, and a non-circular perimeter. Further, the method involves cutting the strip to form at least one burst disk, wherein said cutting comprises removing at least one waste area from the strip. In some embodiments, the method may further comprise the step of removing the waste area, wherein such removal of the waste area from the strip forms one or more arcs in the burst disk. In yet further embodiments, there is no gap between the edges of two adjacent burst disks when these burst disks are cut from the strip of material, i.e., two adjacent burst disks have edges that abut such that a cut line is shared.

The present embodiments relate to a non-circular burst disk that may be used with an inflator that includes an orifice. In some embodiments, the inflator will also comprise a well and the orifice will be positioned at the base of the well. Accordingly, in these embodiments, the burst disk may be nested in the well to seal the orifice. The use of the well may also facilitate the proper positioning of the burst disk. However, the burst disk may also be used with inflators that do not comprise a well. In some of these embodiments that lack a well, the burst disk may be positioned via a tooling or other mechanism designed to ensure proper positioning of the burst disk.

In some embodiments, the burst disk is generally square or rectangular in shape. Other shapes and/or configurations may also be used. In other embodiments, the “corners” of the square or rectangular shape are “rounded off” to form a curved surface (such as an arc).

The burst disk will generally be cut from a strip of material. The strip of material is typically much longer than it is wide and may be rolled up into a coil, meaning it has two longitudinal edges and a lateral width. The two longitudinal edges may be parallel or substantially parallel to each other. Multiple burst disks may be cut from the same strip of material.

The burst disk generally includes a surface. The surface is designed such that it may be disposed adjacent to the orifice in the inflator. The disk may be welded into the proper position. Once the disk has been welded, the disk operates to seal the orifice. By sealing the orifice, the gas stored within the inflator is prevented from exiting out of the inflator until the burst disk is ruptured (which occurs during deployment of the inflator).

The surface comprises a first side and a second side. The surface also includes a non-circular perimeter. Having a “non-circular perimeter” means that the perimeter of the surface, when taken as a whole, is non-circular, even if there are sections or portions of the perimeter that are circular or rounded. The surface will also have diagonals which measure the distance from one edge or corner (or corner portion) to an opposite edge or corner (or corner portion) of the first side. The length of the diagonal is greater than or equal to the diameter of the weld. If the surface were circumscribed in a circular inflator well, the largest diagonal will be slightly less than or equal to the diameter of the inflator well. At the same time, the smallest diagonal will be slightly larger than or equal to the diameter of the weld on the inflator. The weld diameter is slightly larger than the orifice diameter. In this manner, the surface will always cover the orifice for sealing purposes.

Because the burst disk is generally rectangular or square, the non-circular perimeter comprises a plurality of first edges and a plurality of second edges. The first edges may be parallel to each other. Likewise, the second edges may be parallel to each other. These parallel edges ensure that the perimeter is non-circular. The non-circular perimeter may also include a plurality of first arcs and a plurality of second arcs. In some embodiments, the shape and curvature of the first and second arcs will correspond to the shape and/or curvature of the circular well. Again, the arcs may be formed by rounding off the corners of the square or rectangular burst disk.

When the burst disk is cut from the strip of material, the burst disk may be cut in a direction that is parallel to the lateral sides. When the strip is been cut in this manner, the second edges of the disk correspond to a portion of the longitudinal sides of the strip. Similarly, when the strip is cut in this matter, at least one of the first edges of the disk is parallel to the lateral sides of the strip. When the burst disk is cut from the strip of material, a waste area may also be removed. The waste area may constitute all or a portion of the “corner” of the burst disk that was rounded off. In some embodiments, the amount of the waste area may further be reduced by cutting the strip so that there is no gap between the edges of two adjacent burst disks. Rather, when two adjacent burst disks are cut from the strip of material, the adjacent burst disks share a cut line such that there is no space or gap between the trailing edge of the first disk and the leading edge of the second disk.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a perspective view of the prior art method for forming a burst disk;

FIG. 1B is a perspective view of the way in which the prior art burst disk of FIG. 1A interfaces with an orifice in a well of an inflator;

FIG. 2 is a perspective view that illustrates a burst disk according to the present embodiments as well as an embodiment of the way in which this burst disk may be made;

FIG. 3 is a perspective view that illustrates the way in which the burst disk of FIG. 2 may seal the orifice in the well of the inflator;

FIG. 4 is a view that shows the burst disk of FIG. 2 operating to seal the orifice;

FIG. 5 is a top plan view the shows the burst disk of FIG. 2 operating to seal the orifice; and

FIG. 6 is a perspective view of a burst disk according to the present embodiments being used on a different type of inflator.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

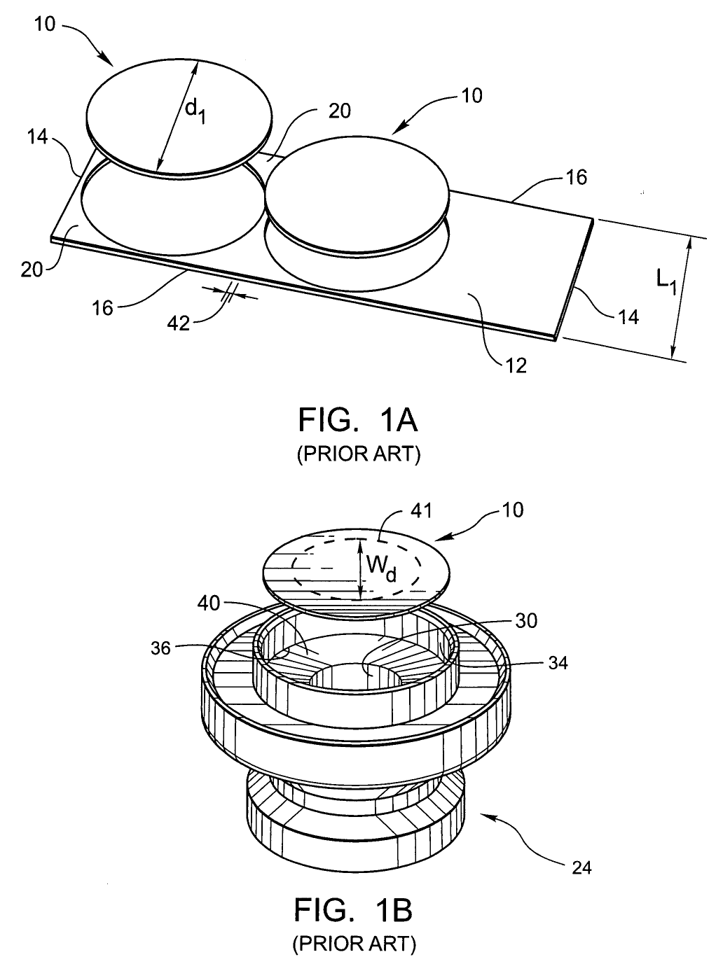

Referring now to FIG. 1A, a representation of the “prior art” is illustrated. Specifically, FIG. 1A is a perspective view that shows burst disks 10 that are formed (or cut) from a strip of material 12. The strip of material 12 may be much longer than it is wide in shape and has lateral width 14 and longitudinal edges 16.

These burst disks 10 are circular in shape. The diameter (d₁) of the circular burst disks 10 are less than the length of the lateral width 14. (The length of the lateral width 14 is indicated as L₁). Accordingly, when the burst disks 10 are cut from the strip of material 12, a waste area 20 is formed. The waste area 20 circumscribes the circular burst disk 10, once the burst disk 10 has been removed from the strip of material 12. Accordingly, the waste area 20 constitutes the amount of material that circumscribes the circular burst disk 10.

Further adding to the waste area 20 is that when two adjacent burst disks 10 are cut from the same strip of material 12, there must be a gap 42 between the edges of each of the burst disks 10. This gap 42 is simply wasted material that will never be used as part of a burst disk 10. Rather, the portion of the strip 12 where the gap 42 is located is simply a portion of the strip 12 that is thrown away.

Referring now to FIG. 1B, the way in which the prior art burst disks 10 may be used is illustrated. Specifically, FIG. 1B shows a top 24 of an inflator (not shown). This top 24 may be attached to a chamber (not shown) that houses a quantity of stored gas (not shown). The top 24 includes an orifice 30 and a well 34 that surrounds the orifice 30. The burst disk 10 may be positioned within the well 34. Accordingly, the diameter d₁ of the burst disk 10 is designed such that it will correspond with the inside diameter of the well 34, i.e., d₁ is slightly less than or equal to the inside diameter of the well 34. (The well 34 is sometimes referred to as a “pocket”). The orifice 30 is positioned at the base 36 of the well 34.

As can be seen in FIG. 1B, the diameter d₁ of the burst disk 10 is larger than the diameter of the orifice 30. This area of the base 36 outside of the diameter of the orifice 30 is referred to as the welding area 40. Once the burst disk 10 is positioned over the orifice 30, the burst disk 10 rests inside the well 34 and covers the welding area 40. This inclusion of the weld area 40 also facilitates positioning of the burst disk 10 within the well 34 during the assembly process. Once the burst disk 10 is thus positioned, the burst disk 10 may be welded along the weld 41 (shown in phantom lines). The weld 41 is circular to match the circular shape of the orifice 30. However, the circular weld 41 has a diameter W_{d} that his greater than the diameter of the orifice 30. Once the burst disk 10 is welded into position, the burst disk 10 seals the orifice 30 so that the stored gas housed within the chamber (not shown) cannot escape. In fact, the gas will be retained within the chamber by the burst disk 10 until the burst disk 10 is failed as part of the deployment process.

The area of the burst disk 10 that is outside the weld 41 does not affect the performance/functioning of the burst disk 10 in any meaningful way. Rather, this area of the burst disk 10 is “excess” material that is used during the manufacturing process to position the burst disk 10 for welding. Sizing the burst disk 10 so that it corresponds to the size of the well 34 produces this excess material. Sizing the burst disk 10 in this manner also facilitates positioning of the burst disk 10 because once the disk 10 is inserted into the well 34, the disk 10 will be immediately positioned over both the welding area 40 and the orifice 30. Thus, after inserting the disk 10 into the well 34, the position of the disk 10 generally will not need to be moved or adjusted.

Referring now to FIGS. 1A and 1B, an example of the sizing of the burst disk 10 is now provided. One type of an inflator is a “30 millimeter” inflator. In this inflator, the diameter of the orifice 30 is approximately 10 millimeters, the diameter of the weld 41 is 14 mm, and the diameter of the well 34 is approximately 17.85 millimeters. In order to make a circular burst disk 10 having a diameter d₁ of 17.85 millimeter (i.e., sized so that the burst disk 10 matches the size of the well 34,), the length of the lateral side L₁ must be at least 18.85 millimeters. Accordingly, in order to properly size this disk, it is estimated that approximately 345.9 mm² of material from the strip 12 is required to produce a disk 10 that will have a size that matches the size of the well 34. Of course, this example of the size of burst disk 10 is only exemplary. A variety of different sizes may be used for the circular burst disk 10.

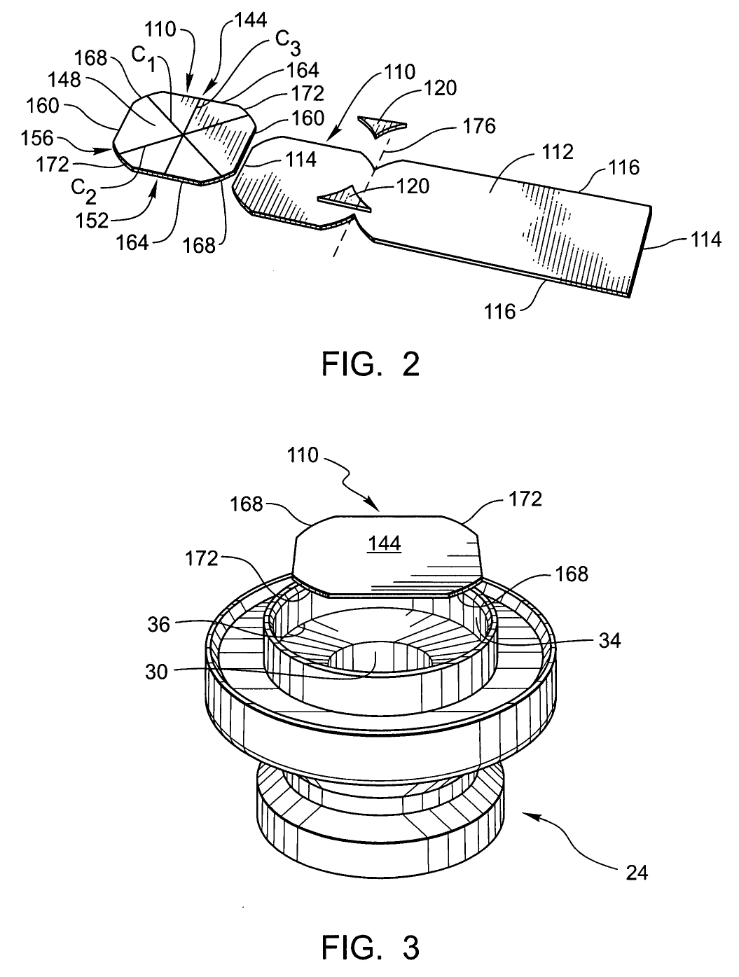

Referring now to FIG. 2, a perspective view of an embodiment of the burst disk 110 according to the present embodiments is illustrated. As is explained herein, some embodiments of the burst disk 110 have advantages over the prior art burst disks 10 of FIGS. 1A and 1B. As shown in FIG. 2, the burst disk 110 is cut out of a strip of material 112. The strip of material 112 may be made of stainless steel, metal, plastic, or other substances used to make burst disks. The strip of material 112 is much longer than it is wide, meaning it has two longitudinal edges 116 and a lateral width 114.

The two longitudinal edges 116 are parallel or substantially parallel to each other. In the embodiment shown in FIG. 2, only a short section of the strip of material 112 is shown and generally the longitudinal edges 116 are much longer than the lateral width 114.

The burst disk 110 may be cut from the strip of material 112. When the burst disk 110 is formed, the burst disk 110 generally includes a surface 144. In some embodiments, the surface 144 may be designed such that it may be nested in the well 34 (not shown in FIG. 2). In other embodiments, the surface may be designed such that, when nested within the well 34, the surface 144 is in a position for sealing the orifice 30 (not shown in FIG. 2).

As shown in FIG. 2, the surface 144 may comprise a first side 148 and a second side 152. The surface 144 also includes a non-circular perimeter 156. Having a “non-circular perimeter” means that the perimeter of the surface 144, when taken as a whole, is non-circular. There may be some regions or portions of the non-circular perimeter 156 that are round or “arc-shaped.” However, there may also be portions of the perimeter that have straight edges. Accordingly, the presence of these straight portions means, that when viewed as a whole, the perimeter does not have a circular shape.

The surface 144 will also have at least one diagonal C₃, which is the distance measured from one side to an opposite side of the first side 148. The length of the diagonal C₃ is greater than or equal to the diameter of the orifice 34 and of the weld diameter 41. In those embodiments that are designed for use in an inflator having a well, the diagonal C₁, which is measured from one corner to an opposite corner, may be slightly less than or equal to the inside diameter of the well 34. In other embodiments, the surface 144 may have additional diagonals measured from the corners (or the corner portions) of the surface. In some embodiments, all of the diagonals will have the same length. In other embodiments, one or more of the diagonals will have a length that is larger or shorter than the length of the other diagonals. In further embodiments, the length of the diagonal C₁ (and/or the other diagonals) is set such that this distance corresponds to the diameter of the well 34 (not shown in FIG. 2).

In the embodiment shown in FIG. 2, the non-circular perimeter 156 comprises a plurality of first edges 160 and a plurality of second edges 164. As shown in FIG. 2, the first edges 160 are parallel to each other. The second edges 164 are also parallel to each other. The first and second edges 160, 164 are linear sections, and thus, the inclusion of the first and second edges 160, 164 ensures that the perimeter 156 is non-circular.

The non-circular perimeter 156 may also include a plurality of first arcs 168 and a plurality of second arcs 172. As shown in FIG. 2, there are two first arcs 168 and there are two second arcs 172. The plurality of first arcs 168 may share at least one common diagonal (which is the diagonal C₁). The plurality of second arcs 172 may also share at least one common diagonal. As shown in FIG. 2, the plurality of second arcs 172 may share the common diagonal C₂. Other embodiments may be designed in which the plurality of first arcs 168 do not share a common diagonal. Still further embodiments may be designed in which the plurality of second arcs 172 do not share a common diagonal.

In some embodiments, the shape and curvature of the first arcs 168 will correspond to the shape and/or curvature of the inside of the circular well 34. In other embodiments, the shape and curvature of the second arcs 172 will correspond to the shape and/or curvature of the inside of the circular-shaped well 34.

As shown in FIG. 2, the surface 144 is designed such that it is shaped as a rectangle or square in which the corners have been “rounded off” to form the arcs 168, 172. Accordingly, the embodiment shown in FIG. 2 contains 4 edges and 4 arcs (which are derived from “rounding off” the corners of the rectangular or square shaped surface 144). Other embodiments may be designed in which more or less than 4 edges are used for the surface 144. Further embodiments may be designed in which more or less than 4 arcs may be used. Other shapes and/or configurations for the surface 144 and/or the non-circular perimeter 156 may be used. By way of example, a burst disk that has the shape of a regular or irregular polygon may be used. In these embodiments in which the burst disk comprises a polygon, one or more of the corners may be rounded off.

The burst disk 110 may be cut (or otherwise derived) from the strip of material 112. In fact, the strip 112 may be designed such that multiple burst disks 112 can be cut or taken from the strip of material 112. In some embodiments, the burst disks 110 are formed by cutting the strip 112 in a direction that is parallel to the lateral sides 114. When the strip 112 is being cut in this manner, the second edges 164 correspond to a portion of the longitudinal sides 116 of the strip of material 112. In other words, the second edges of the burst disk 110 are simply portions of the longitudinal sides of the strip 112. Similarly, when the strip 112 is cut in this matter to form the burst disks 110, at least one of the first edges 160 is parallel to the lateral sides 114 of the strip of material 112. In other words, the first edges 160 will either be a portion of the lateral side 114 or will be parallel to the lateral side 114. Further embodiments may be designed in which one or more of the first edges 160 correspond to the longitudinal sides 116. Other embodiments may be designed in which the second edges 164 corresponds to (or is parallel to) the lateral sides 114. Hence, an array of burst disks 110 may be cut from a sheet of material 112.

When the burst disk 110 is cut from the strip of material 112, a waste area 120 may be removed. In other embodiments, more than one waste area 120 may be removed. In the embodiment shown in FIG. 2, the waste area 120 constitutes all or a portion of the “corner” of the burst disk 110 or adjacent burst disks 110. As noted above, this “corner” may be rounded off to form the arcs 168, 172. The area of the “corner” that is removed to form the arcs 168, 172 constitutes the waste area 120. As can be seen in FIG. 2, the amount of the waste area 120 is minimal and is much smaller than the waste area 20 shown in FIG. 1A. By reducing the amount of the waste area 120, less of the strip of material 112 is wasted. In turn, such a reduction in the amount of material wasted during the cutting process means that the manufacturer can buy significantly less material 112, and yet still produce the same number of burst disks 110. Thus, the overall costs associated with manufacturing the disks 110 decreases.

In some embodiments, the amount of the waste area 120 may further be reduced by cutting the strip 112 along a cut line 176 common to adjacent burst disks 110 so that there is no gap between the edges of two adjacent burst disks 110. Rather, when two adjacent burst disks 110 are cut from the strip of material 112 along the cut line 176, there is no space or gap between the trailing edge of the first disk and the leading edge of the second disk.

Referring now to FIG. 3, the burst disk 110 of FIG. 2 is illustrated as this disk 110 is being installed onto a top 24. The top 24 is similar and/or identical to that which was described in conjunction with FIG. 1. Accordingly, for purposes of brevity, this discussion will not be repeated.

It should be noted that the use of the burst disk 110 in conjunction with a well 34 (or an inflator having a well 34) is provided for illustrative purposes only. Other embodiments of the present burst disks may be used with other types of inflators, including those inflators that do not include a well (or other similar structure). In fact, as long as the inflator has an orifice, this orifice may be sealed with embodiments of the burst disks described herein.

As shown in FIG. 3, the burst disk 110 may be positioned within the well 34. Accordingly, the diagonal C₁ of the burst disk 110 may be designed such that it will correspond with the inner diameter of the well 34. The diagonal C₃ of the burst disk 10 is larger than the diameter of the orifice 30. At the same time, the shape of the arcs 168, 172 is designed to correspond with the shape of the rounded (circular) well 34. Further, by having the arcs 168, 172 correspond to the shape of the well 34, a worker can easily position the disk 110 in the proper configuration by simply aligning the arcs 168, 172 within the well 34. In other embodiments, the shape of the arcs 168, 172 will interface with a tooling used during the manufacturing process to further facilitate the alignment of the burst disk 110.

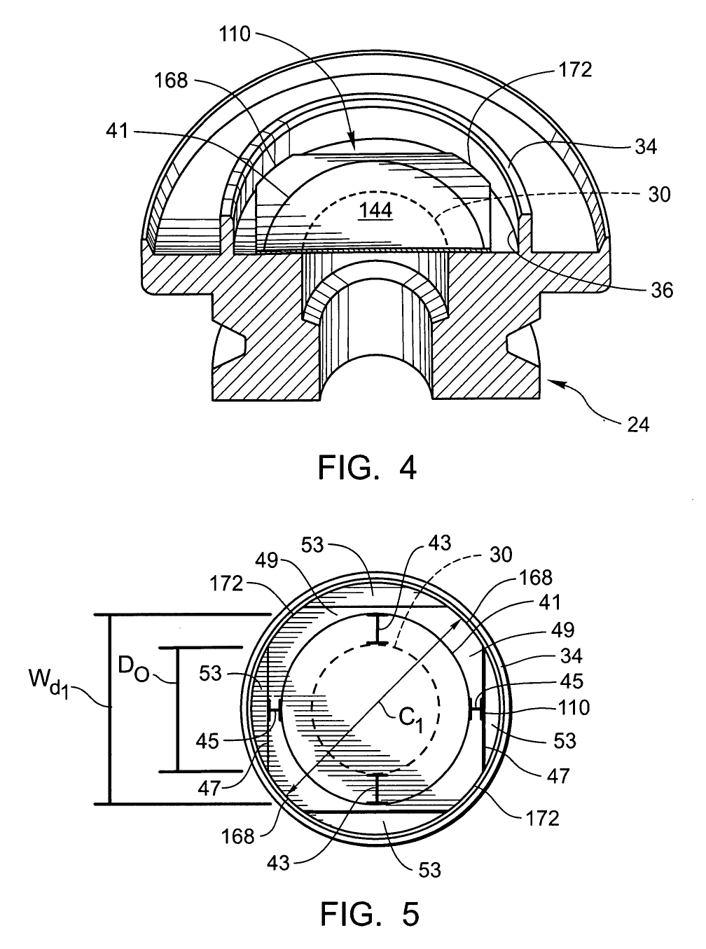

Referring now to FIG. 4, the burst disk 110 is positioned at the base 36 of the well 34. As can be seen in FIG. 4, the burst disk 110 covers the orifice 30 and may be used to seal the orifice (and thus hold gas within the inflator). Once the burst disk 110 is positioned over the orifice 30, the burst disk 30 may be welded (or otherwise permanently attached) in its proper position. The weld 41 is illustrated on FIG. 4. The weld 41 is a circular ring that circumscribes the orifice 30. The weld 41 has a diameter W_{d1} (shown in FIG. 5) that is larger than the diameter of the orifice 30.

The burst disk 110 may be designed to seal the orifice 30 when the disk 110 is welded into the proper position. In some embodiments, when the burst disk 110 is positioned in the well 34, the well 34 may circumscribe the burst disk 110, as shown in FIG. 4. (In other words, the burst disk 110 may be inscribed within the well 34.) Similarly, when the burst disk 110 is positioned over the orifice 30, the burst disk 110 may be oriented such that the orifice 30 may be inscribed by the burst disk 110.

FIG. 5 is a top plan view that is similar to FIG. 4 and illustrates the burst disk 110 being used to seal the orifice 30. The weld 41 operates to seal the orifice 30 and permanently affix the burst disk 110. The diameter W_{d1} of the weld 41 is larger than the diameter D₀ of the orifice 30.

Generally, the distance between the circular weld 41 and the orifice 30, which is illustrated with distance marker 43, is selected to be the minimum distance necessary to ensure the disc 110 will rupture the burst disk 110 inside of the orifice diameter, and will not rupture at the weld 41. In some embodiments, this distance will be about 2 to 3 millimeters (including 2.3 millimeters) to ensure that the weld 41 is not compromised during deployment. However, other distances are also possible, depending upon the particular embodiment. Those of skill in the art will appreciate how this distance can be ascertained (via testing, etc.). Obviously, manufacturers may construct embodiments in which the distance 43 is kept as small as possible, so that (in turn) the burst disk 110 can be made as small as possible. By making the disk 110 as small as possible, the amount of raw material needed in the manufacturing process will be reduced and the overall production costs associated with producing the disk 110 will also decrease.

The outside edges 47 of the burst disk 110 needs to be just far enough outside the weld 41 to prevent the edge 47 from melting out, being compromised, or otherwise failing during the welding process. This distance between the edge 47 and the outside of the weld 41 is marked with distance marker 45. In some embodiments, this distance 45 will be about 0.5 millimeter. However, other distances are also possible, depending upon the particular embodiment. Those of skill in the art will appreciate how this distance can be ascertained (via testing, etc.). Obviously, manufacturers may construct embodiments in which the distance 45 is kept as small as possible, so that (in turn) the burst disk 110 can be made as small as possible. Again, constructing the disk 110 as small as possible may be advantageous in that it reduces the amount of material needed in the manufacturing process and reduces the overall production costs.

FIG. 5 also illustrates the way in which using the burst disk 110 may require less material than does a corresponding “circular” burst disk of the prior art. As described above in conjunction with FIGS. 1A and 1B, the previously known burst disks 10 are designed such that the burst disk 10 (shown in FIG. 1A) has a diameter that is equal to the diameter of the well 34. Further, as discussed above, this “circular” burst disk is created by cutting a circular piece out of a square (or rectangular) area of material. Accordingly, the actual area of material needed to construct the burst disk 10 is actually greater than the circular area of the well 34. (It is for this reason, as shown above, that a waste area 20 (shown in FIG. 1A) that circumscribes the circular burst disk 10.)

However, as shown in FIG. 5, the amount of material needed to construct the burst disk 110 is much less than that which is necessary for the burst disk 10 of the prior art. The burst disk 110 covers the same weld diameter W_{d1} and orifice 30, yet requires significantly less material and is significantly smaller than the size of the well 34. As shown in FIG. 5, the square burst disk 110 can be cut/formed from a much narrower strip of material 112 (not shown in FIG. 5, see FIG. 2) than that which would be needed for a circular (prior art) burst disk 10 having a size to match the size of the well 34. Accordingly, by using a narrower strip of the material 112, the amount of material 112 used is reduced and the manufacturing costs are greatly diminished.

Referring still to FIG. 5, it is noted that the first arcs 168 and second arcs 172 contact the well 34, despite the reduction in the amount of material used to construct the burst disk 110. The arcs 168, 172 are positioned exterior of the weld 41. It is noted that, in some embodiments of the burst disk 110, a portion of the material 49 is needed outside the weld 41 to position the disk 110 during installation process and during the welding process. In other words, an exterior portion 49 of the material is located outside of the weld 41 to facilitate the alignment and positioning (either by hand or via a tooling) of the burst disk 110. However, once the burst disk 110 is welded, the external material serves no other function. With a square disk 110, this material outside the weld 41 (i.e., the external portion 49) is minimized because only the corners are used for positioning. At the same time, there is a sufficient amount of material 49 (and area) in the disk 110, including the arcs 169, 172, which may allow an installer to readily position the disk 110.

FIG. 5 also provides a comparison of how, in some embodiments, the burst disk 110 may be smaller than the burst disk 10 (shown in FIG. 1A) of the prior art. As noted above, the burst disk 10 is generally designed such that it will fill the well 34. In other words, the diameter of the burst disk 10 is set such that it corresponds to the diameter of the well 34. With respect to the present burst disk 110, the diagonal C₁ may be sized such that it corresponds to the diameter of the well 34 (and thus corresponds to the diameter of the circular burst disk 10). At the same time, the burst disk 110 is smaller than the burst disk 10 in that the burst disk 110 does not include four exterior curved sectors 53 that are present in circular the burst disk 10. (As the burst disk 10 is circular and fits in the well, the circular burst disk 10 clearly includes these sectors 53.) Rather, because the burst disk 110 is generally square or rectangular in shape, these curved sectors 53 are lacking in the burst disk 110, and the burst disk 110 is thus smaller than the burst disk 10 and may be constructed from a smaller (narrower) strip of material.

Referring now to FIGS. 2-5 collectively, the non-circular shape of the burst disk 110 may result in a reduction of the amount of material wasted and/or required to construct the burst disk 110. As noted above, using a “circular” burst disk for a 30 millimeter inflator requires approximately 345.9 mm² of material from the strip. For this 30 millimeter inflator, the actual size of the weld 41 has a diameter of only 14.88 millimeters and an area of only about 173.9 mm². However, using the non-circular configuration of the present embodiments, the amount of material required can be drastically reduced. Specifically, embodiments of the burst disk 110 may be constructed in which the length of the lateral width 114 is only 15.07 millimeters (as opposed to 18.85 millimeters in a circular disk). Likewise, the burst disk 110 is dimensioned such that diagonals C₁ and C₂ may be set such that the length of the diagonal is 17.85 millimeters. With these dimensions, the amount of material needed to construct the burst disk 110 is approximately 227.2 mm². (As noted above, a similar “circular” burst disk for use in a similarly sized well 34 requires approximately 345.9 mm² of material from the strip). Thus, the burst disk 110 is much smaller in size and results in a net material savings of about 34.3%. Yet, despite the reduction in the size of the disk 110, the disk 110 is still large enough to adequately cover and seal the orifice 30. Additionally, the “wasted area” of material 120 that is outside of the area of burst disk that has been trimmed off is also less than the waste area 20 (shown in FIG. 1A) created when producing a circular burst disk.

In other embodiments, a circular disk with a diameter of 14.7 millimeters may be cut into a rounded corner square, as taught herein, with a size of 11.0 millimeters. This smaller “square” burst disk could still adequately seal an inflator orifice, but would result in an overall savings in raw material of about 43.7%. Likewise, a circular disk with a diameter of 13.3 millimeters could be cut into a rounded corner square, as taught herein, with a size of 11.4 millimeters. This smaller “square” burst disk could still adequately seal an inflator orifice, but would result in an overall savings in raw material of about 26.2%. These particular embodiments are given as examples only. Other sizes of square burst disks may be used, as desired.

Further, the present embodiments also relate to a method for reducing waste while producing one or more non-circular burst disks. In general, this method will involve obtaining a strip of material 112 that comprises two longitudinal sides 116 and a lateral width 114. Once the strip of material 112 has been obtained, the next step of the method involves identifying where the strip 112 can be cut to form at least one burst disk 110. Then, the strip 112 will be cut to form at least one burst disk. Such cutting of the strip 112 comprises removing at least one waste area from the strip. Such cutting of the strip may also involve pressing, stamping, or other forms of creating the disks 110 from a strip or sheet of material 112. It should be noted that in some cases, a completely square disc with no rounded corners might work and function in the manner discussed herein, in which case, there may not be any wasted area.

It should be noted that this step of cutting the strip may be performed in other ways. For example, a sheet of material may provide an array of strips positioned adjacent to each other so that burst disks may be stamped, cut, or otherwise created at the same time. By way of example, this may involve placing a variety of strips next to each other and then stamping this plurality of strips at the same time, thereby removing all of the waste areas simultaneously. In other embodiments, other polygonal shaped strips may be cut, stamped etc.

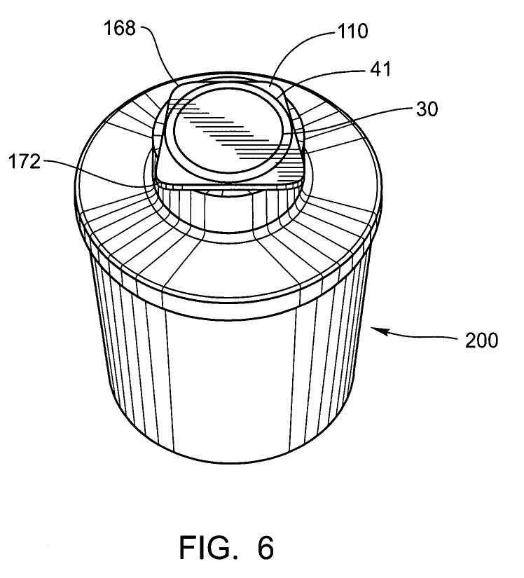

Referring now to FIG. 6, a perspective view illustrates the burst disk 110 being used to seal an orifice 30 on an inflator 200. The burst disk 110 is similar to that which is described above. However, the inflator 200 differs from that which is described above in that the inflator 200 does not include a well 34 (or other similar structure). Rather, the burst disk 110 operates to seal the orifice 30, without having the burst disk 110 being nested or positioned in a well. The embodiment of FIG. 6 shows, for purposes of illustration, that the burst disks of the present embodiments may be used with all types of inflators, including those that do or do not have a well.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A burst disk for use in an inflator having an orifice, the burst disk comprising:
a surface for disposition adjacent the orifice, the surface comprising:
a first side, a second side, and a non-circular perimeter, wherein at least one diagonal across the first side is greater than or equal to the diameter of the orifice.

2. The burst disk as in claim 1 wherein the non-circular perimeter comprises a plurality of first edges, wherein the first edges are parallel.

3. The burst disk as in claim 1 wherein the non-circular perimeter comprises a plurality of second edges, wherein the second edges are parallel.

4. The burst disk as in claim 1 wherein the non-circular perimeter comprises a plurality of first arcs.

5. The burst disk as in claim 4, wherein the plurality of first arcs that share a common diameter.

6. The burst disk as in claim 5, wherein the non-circular perimeter further comprises a plurality or second arcs that share a common diameter.

7. The burst disk as in claim 6 wherein the inflator further comprises a circular well that receives the burst disk, wherein the first and second arcs correspond to the circular arc of the well.

8. The burst disk as in claim 6 wherein the burst disk is welded to a welding area positioned proximate the orifice.

9. The burst disk as in claim 1 wherein the burst disk is positioned such that orifice is inscribed within the burst disk.

10. The burst disk as in claim 1, further comprising a circular weld positioned exterior of the orifice, wherein the diameter of the circular weld is greater than the diameter of the orifice.

11. The burst disk as in claim 10 wherein the distance between the circular weld and the orifice is selected such that the weld is not compromised during deployment.

12. The burst disk as in claim 10 wherein the weld is separated from the edge of the burst disk by a distance sufficient to ensure that the edge is not melted during the welding process.

13. The burst disk as in claim 1 wherein the burst disk lacks four exterior curved sectors that are present in circular burst disks.

14. A method for reducing waste while producing one or more non-circular burst disks for use in an inflator with an orifice, the method comprising:
obtaining a strip of material, the material comprising two longitudinal sides and a lateral width;
identifying where the strip can be cut to form at least one burst disk, wherein the burst disk comprises a surface for disposition adjacent the orifice, the surface comprising a first side, a second side, and a non-circular perimeter, wherein at least one diagonal across the first side is greater than the diameter of the orifice; and
cutting the strip to form at least one burst disk.

15. The method as in claim 14, wherein said cutting comprises removing at least one waste area from the strip.

16. The method as in claim 15 wherein the non-circular perimeter comprises a plurality of first edges and a plurality of second edges, wherein the plurality of second edges correspond to the portions of the longitudinal sides of the strip of material, and wherein at least one of the plurality of first edges is parallel to the lateral width of the strip of material.

17. The method as in claim 16 wherein there is no gap between the edges of two adjacent burst disks when these burst disks are cut from the strip of material.

18. The method as in claim 16 wherein removing the waste area from the strip forms one or more arcs in the burst disk.
